(19) United States
(12) Patent Application Publication
(10) Pub. No.: US 2010/0164975 A1
(43) Pub. Date: Jul. 1, 2010

(54) Picture Signal Processing Device, Picture Signal Processing Method, and Picture Display Device

(76) Inventor: Kiyoshi Kogure, Konosu-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/640,714

(22) Filed: Dec. 17, 2009

(30) Foreign Application Priority Data
Dec. 25, 2008 (JP) 2008-331347

(51) Int. Cl. G09G 5/02; G06K 9/00

(52) U.S. Cl. 345/589; 382/169

(57) ABSTRACT

According to one embodiment, a picture signal processing device comprises a histogram detection module configured to detect a histogram related to luminance from a picture signal for each frame, a change amount calculation module configured to discriminate a luminance component with a level larger than a defined level from the histogram for each frame to calculate a luminance change amount for each frame, and a display control module configured to discriminate a period in which the luminance change amount exceeds a threshold, specify at least the period as a flashing screen, suppress display luminance of the picture signal, grasps which of luminance components is most densely distributed for each frame by the histogram detection module, and detects the flushing screens with high precision on the basis of the grasped information on the distribution.

### CROSS-REFERENCE TO RELATED APPLICATIONS

This application is based upon and claims the benefit of priority from Japanese Patent Application No. 2008-331347, filed Dec. 25, 2008, the entire contents of which are incorporated herein by reference.

### BACKGROUND

1. Field

One embodiment of the invention relates to a picture signal processing device which apply processing preventing a so-called optical sensibility trouble upon displaying a picture display; and relates to a picture signal processing method, and a picture display device.

2. Description of the Related Art

In recent years, with progress of a picture technique, special picture methods for animation programs, games, etc., are frequently employed; however, among of the picture methods, flashing pictures finely flashing (drastically changing the luminance in short cycles) are considered as a problem which is a cause of a so-called optical sensibility trouble having influences on the health of infants and children. As for a method for avoiding this problem, motion picture processing which monitors a time change in a frame image, inspects a luminance change in a unit time, detects a luminance change equal to or larger than a fixed level, and controls display luminance, etc., in response to the frequency is proposed in Jpn. Pat. Appln. KOKAI Publication No. 2006-191227.

However, since the above proposed motion picture processing calculates frame averaged luminance of input picture signals, detects a luminance change based on the averaged value, and detects a maximum luminance signal at a luminance flashing part; the proposed processing only detects an overall change in on a screen, and then cannot detect only rough flashing pictures.

As described above, the conventional picture signal processing technique has low detection precision of the flashing pictures, so that it is hard to effectively suppress the luminance change amount of the flashing pictures.

### BRIEF DESCRIPTION OF THE SEVERAL VIEWS OF THE DRAWINGS

A general architecture that implements the various feature of the invention will now be describe with reference to the drawings. The drawings and the associated descriptions are provided to illustrate embodiments of the invention and not to limit the scope of the invention.

FIG. 1 is an exemplary block diagram depicting a configuration of a picture display device with a picture signal processing device of an embodiment of the invention;

FIG. 2 is an exemplary block diagram depicting a specific configuration of the picture signal processing device depicted in FIG. 1;

FIG. 3 is an exemplary block diagram depicting a specific configuration of a histogram processing function depicted in FIG. 2;

FIG. 4 is an exemplary flowchart depicting a flow of processing of the histogram processing function mounted on a control module 125 depicted in FIG. 2;

FIG. 5 is an exemplary view depicting a specific example of a histogram in the foregoing histogram processing function;

FIGS. 6A and 6B are exemplary views depicting gradation of a histogram in an entire black screen and an entire while screen, respectively; and

FIGS. 7A to 7C are exemplary views for explaining procedures of detection of flashing screens by the histograms, respectively.

### DETAILED DESCRIPTION

Various embodiments according to the invention will be described hereinafter with reference to the accompanying drawings. In general, according to one embodiment of the invention, there is provided a picture signal processing device, comprising: a histogram detection module configured to detect a histogram related to luminance from a picture signal for each frame; a change amount calculation module configured to discriminate a luminance component having a defined level or more from the histogram for each frame to calculate a luminance change amount for each frame; and a display control module configured to discriminate a period in which the luminance change amount exceeds a threshold and specify at least the period as a flashing screen to suppress display luminance of the picture signal.

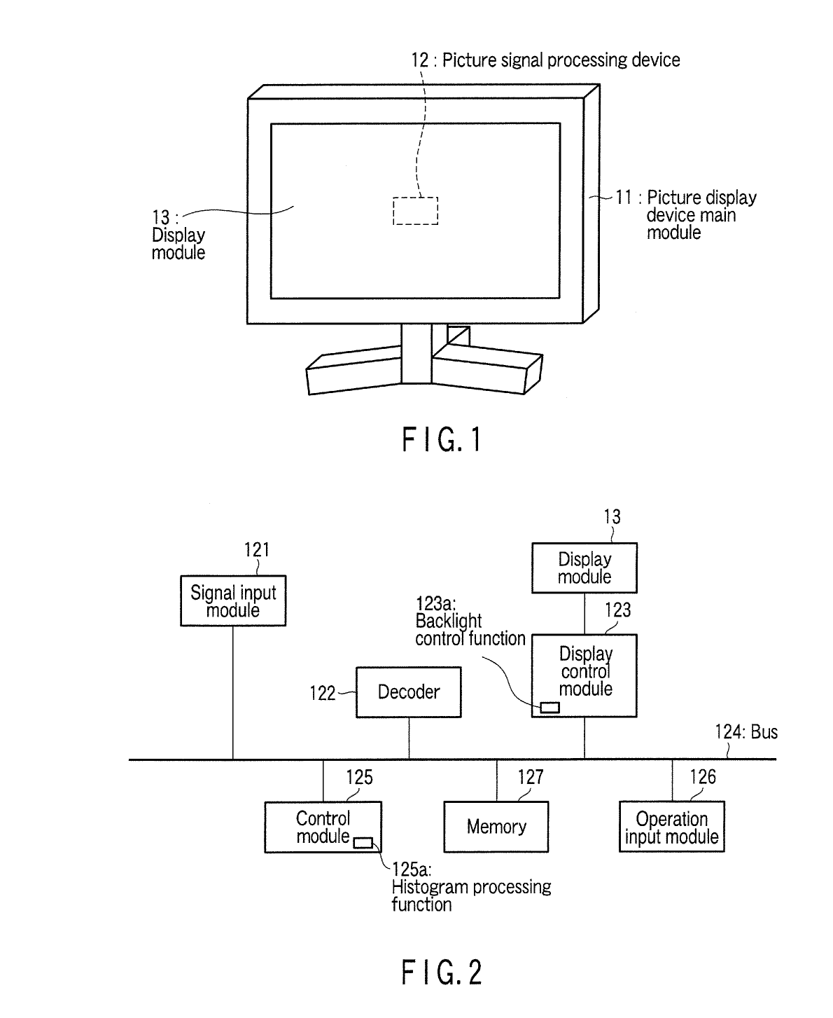

FIG. 1 shows a block diagram illustrating a configuration of a picture display device with a picture signal processing device of an embodiment of the invention. The picture display device shown in FIG. 1 is configured to install, in a picture display device main module 11, a picture signal processing device 12 applying predetermined signal processing to an input picture signal, and to output the picture signal processed by the processing device 12 to a display module 13. In the embodiment, the display module 13 uses a liquid crystal display (LCD) to control the luminance of the display by a backlight.

FIG. 2 shows a block diagram illustrating a specific configuration of the processing device 12. In FIG. 2, a signal input module 121 is configured to input the picture signal output from a picture reproduction device, etc., the picture signal input to the spinal input module 121 is decoded by a decoder 122, and then applied display control for such as brightness and contrast, etc., from a display control module 123 to be supplied to the display module 13. The display control module 123 has a backlight control function 123a configured to control a light amount of the backlight of the display module 13.

The signal input module 121, the decoder 122, and the display control module 123 are connected to a bus 124. A control module 125, an operation input module 126 and a memory 127 are connected to the bus 124. The control module 125 applies predetermined processing to the signal input module 121, the decoder 122 and the display control module 123 in accordance with instructions form the operation input module 126. Further, the control module 125 appropriately takes in arbitrary picture signals in series into a memory for work 127, executes a pre-registered program, and then can perform arbitrary signal processing. In the embodiment, the control module 125 adds the histogram processing function 125a as the signal processing.

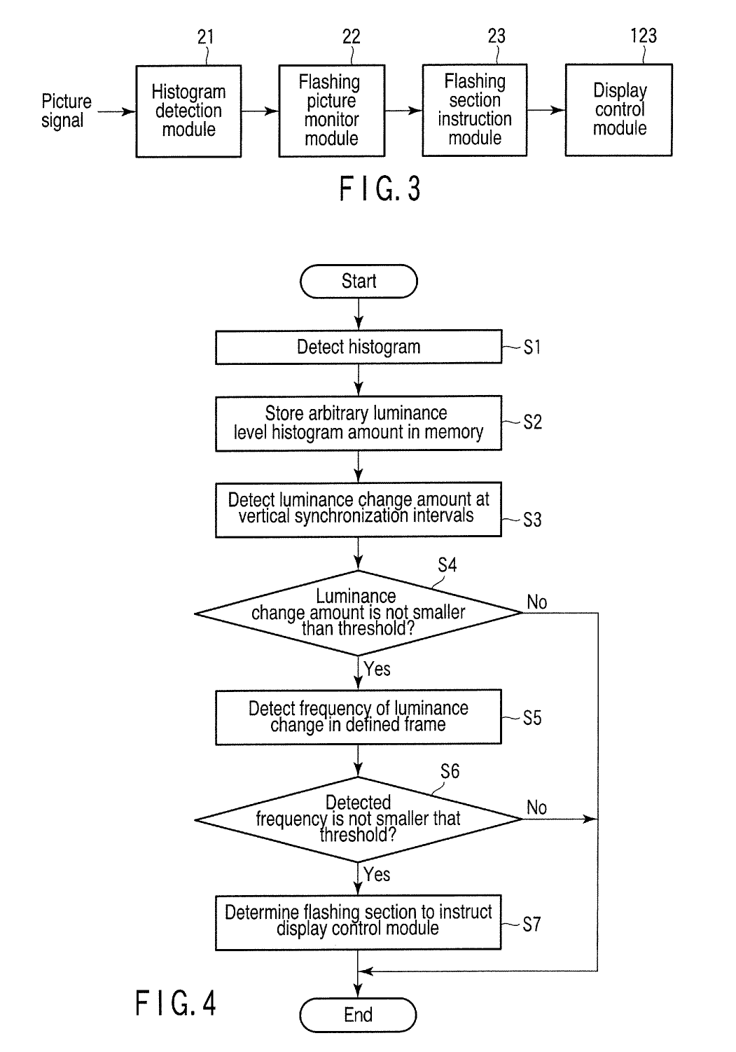

FIG. 3 shows a block diagram illustrating a specific configuration of the foregoing histogram processing function 125a. In FIG. 3, a histogram detection module 21 takes in the picture signal decoded by the decoder 122, calculates frequency distribution related to the luminance on the basis of predetermined gradations, and then detects the histogram. A flashing picture monitor module 22 monitors the generation of the flashing pictures in which luminance levels in a higher area drastically change from the detected histogram. When the flashing pictures are found, a flashing section instruction module 23 instructs the flashing section to a display control module 123, reduces the brightness of the backlight of the display module 13 through the backlight control function 123a of the display control module 123, and thus, suppresses the change amount of the luminance.

In the aforementioned configuration, a control operation for suppressing the luminance change amount of the flashing pictures will be described hereinafter.

FIG. 4 shows a flowchart illustrating the flow of processing of the histogram processing function 125a mounted on the control module 125. At first, the picture signal is input, and when obtaining the decoded output, the control operation detects the histogram showing luminance distribution of the picture signal from the decoded output (Step S1), stores histogram amounts (data) not smaller than an arbitrary luminance level in a memory 126 in vertical synchronization periods (for each frame) (Step S2), and detects luminance change amounts at vertical synchronization intervals by comparing in turn the stored histogram amounts with each other (Step S3). Here, the control operation determines whether or not the luminance change amount exceeds the threshold (Step S4), and if the luminance change amount exceeds the threshold, detects periodicity (frequency) of luminance changes in a defined frame from the luminance change amount for each vertical synchronization detected in Step S4 (Step S5).

Successively, the control operation determines whether or not the frequency (period) detected in Step S5 (Step S6), if the frequency exceeds the threshold, instructs a flashing section start to the display control module 123 as the generation of the flashing screen, at the time when the frequency becomes not larger than the threshold, instructs a flashing section end thereto (Step S7), and ends a series of processing. When receiving instructions of the start and the end of the flashing section, the display control module 123 reduces the light amount of the backlight of the display module 13 only during the flashing section. Thereby, even if the luminance of the picture signal is drastically changed, since the brightness of the entire screen becomes dark, an encouragement degree due to the flashing is reduced, and the display control module 123 effectively functions as measures to prevent an optical sensibility trouble.

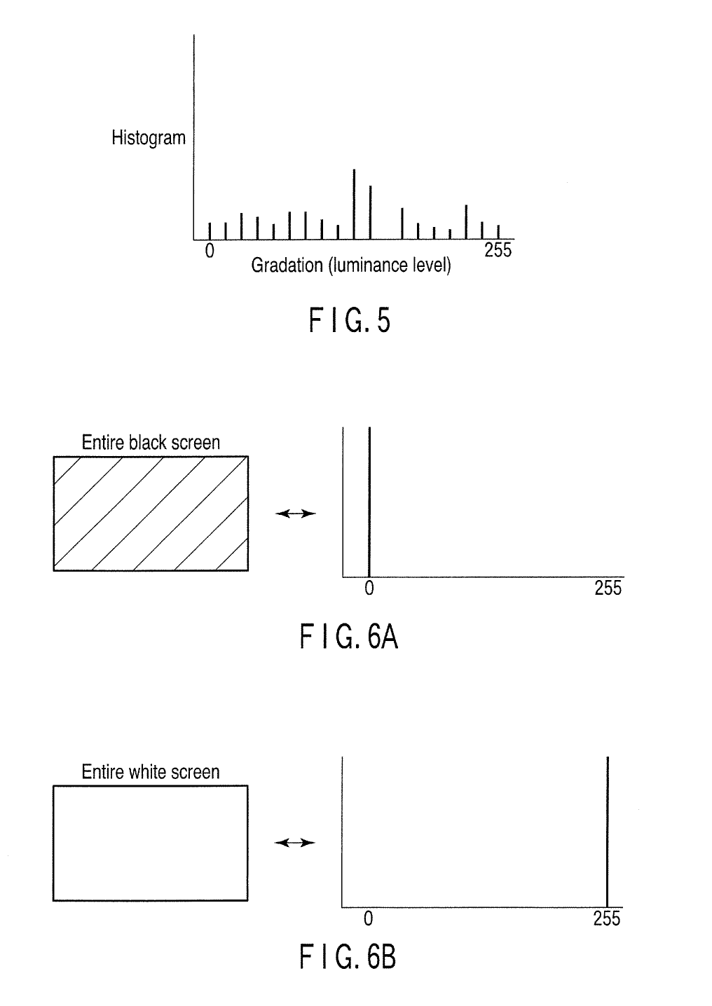

Specific processing content will be described with reference to FIGS. 5 to 7.

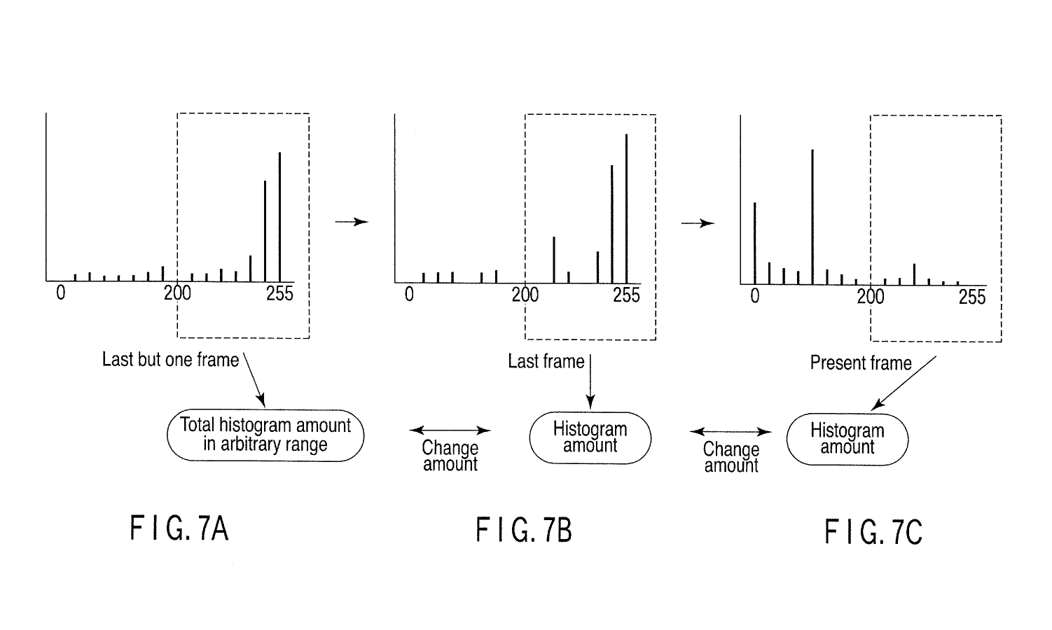

Now, if it is assumed that a histogram detection module 21 has a luminance level detection function of 8-bit, the luminance detected level of the histogram becomes possible to the detection in 0 to 255 gradations as shown in FIG. 5. Here, a case of detection with only 0 gradation as shown in FIG. 6A means an entire black screen, and a case of detection with only 256 gradations as shown in FIG. 6B means an entire white screen as shown in FIG. 65. Detecting the histogram by taking in the luminance level of the input picture signal in frames (by a vertical synchronization module), luminance distribution is obtained, for example, as shown in FIG. 7.

In the foregoing histogram, the histogram detection module 21 pays attentions to a high gradation part not lower than upper order 200 gradations which are assumed to extremely influence on one's health, computes a change amount of each histogram amount of a last but one frame, a last frame and a present frame as shown in FIGS. 7A to 7C, and if the histogram amount changes, for example, 10% or more from the computation results, measures the periodicity (frequency), and determines of generation of the flashing screen if the measurement result exceeds a defined value, so that high detection efficiency can be obtained. Since only a part of the gradations is registered in the memory 126, the memory capacity can be reduced.

As a result of the description above, since the picture signal processing device of the invention can grasp which of the luminance components is densely distributed for each frame by means of the histogram detection, the processing device can detect the flushing screen with high precision. Since the picture signal processing device can freely set the detection range of the luminance change amount, the processing device can detect the flushing screens with higher precision. For instance, paying attention to a high gradation part assumed to heavily influence on one's health, detecting the histogram amount of this part, and detecting the luminance change amount and the period of the flashing screens enables reducing the memory capacity and obtaining high detection efficiency.

If a viewer becomes a certain age older than an adult, the troubles mentioned above are not paused. In this case, by instructing on/off of the efficiency of reducing the luminance change on the flashing screen from the operation input module 126 so as to reproduce the original picture luminance signal, the processing device can have a function of enabling or disabling flushing screen suppression by a histogram processing function of the control module 125. More specifically, for example, when the flashing screen is determined, the embodiment can configure the picture signal processing device 12 so as to control for displaying a graphical user interface (GUI), allowing a user select whether or not the display luminance is suppressed, on a screen, and allowing the user to select whether or not the suppression of the display luminance should be performed.

While the embodiment has been described in a case where the LCD is used for the display module 13, it goes without saying that a display device of another system, such as a Braun tube, a plasma display device can be used in a similar way by detecting the section the flashing screen to control the luminance level. Accordingly, a means for suppressing the display luminance is not limited to the luminance control of the backlight.

Further, while the embodiment has been described only about the picture signal, the picture signal is usually accompanied by a sound signal. In this case, it takes a long time to detect the flashing section, so that the flashing section synchronizes with a luminance suppression period by delaying the display of the picture signal. Therefore, by delaying the sound signal by matching with the picture signal, the sound signal can be simultaneously synchronized with the picture signal.

Other than this, the invention is not limited to the specific details and representative embodiments shown and described herein, and in an implementation phase, this invention may be embodied in various forms without departing from the spirit or scope of the general inventive concept thereof. Each of the embodiments can be implemented by appropriately combining as many as possible, and the combination produces satisfactory results. Further, the aforementioned embodiments include a various steps of the invention; various types of the inventions can be extracted by appropriately combining a plurality of constituent elements to be disclosed. Even in some of the elements, for example, are omitted from all the constituent elements shown in the embodiments, objects described in the column of the “Problem to be Solved” can be solved, and in a case where the effects described in the column of the “Effects of the Invention” can be obtained, the configuration from which the constituent elements are omitted may be extracted as the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture signal processing device comprising:
a histogram detection module configured to detect a histogram related to luminance from a picture signal for each frame;
a change amount calculation module configured to discriminate a luminance component with a level larger than a defined level from the histogram for each frame to calculate a luminance change amount for each frame; and
a display control module configured to discriminate a period in which the luminance change amount exceeds a threshold, specify at least the period as a flashing screen, and suppress display luminance of the picture signal.

2. The device of claim 1 further comprising:
a frequency calculation module configured to calculate a frequency of a luminance change from the luminance change amount calculated by the change amount calculation module, wherein
the display control module discriminates a period in which the luminance change amount exceeds the threshold and the frequency calculated by the frequency calculation module exceeds a defined value.

3. The device of claim 1, wherein
the display control module controls brightness of a backlight of a liquid crystal display module.

4. The device of claim 1 further comprising:
a selection module configured to select on and off of suppression of the display luminance of the picture signal for the display control module in accordance with an instruction input by a user.

5. A picture signal processing method comprising:
detecting a histogram related to luminance of a picture signal for each frame;
discriminating a luminance component larger than a defined level from a histogram detected for each frame to calculate a luminance change amount for each frame; and
discriminating a period in which the luminance change amount exceeds a threshold, specifying at least the period as a flashing screen, and suppressing display luminance of the picture signal.

6. The method of claim 5 further comprising:
calculating a frequency of a luminance change from the luminance change amount; and
discriminating a period in which the luminance change amount exceeds the threshold and the frequency of the luminance change exceeds a defined value.

7. The method of claim 5, wherein
the suppressing of the display luminance controls brightness of a backlight of a liquid display module.

8. The method of claim 5, wherein
the suppressing of the display luminance is selected in accordance with an instruction input by a user.

9. A picture display device comprising:
a histogram detection module configured to detect a histogram related to luminance of a picture signal for each frame;
a change amount calculation module configured to discriminate a luminance component with a level larger than a defined level from a histogram for each frame, and calculate a luminance change amount for each frame;
a flashing screen detection module configured to discriminate a period in which the luminance change amount exceeds a threshold, specify at least the period as a flashing screen, and suppress display luminance of the picture signal; and
a display module configured to suppress brightness of a display screen for the period detected as the flashing screen.

10. The device of claim 9 further comprising:
a frequency calculation module configured to calculate a frequency of a luminance change from a luminance change amount calculated by the change amount calculation module, wherein
the display control module discriminates a period in which the luminance change amount exceeds the threshold and the frequency calculated by the frequency calculation module exceeds a defined value.

11. The device of claim 9, wherein
the display control module controls brightness of a backlight of a liquid crystal display module.

12. The device of claim 9 further comprising:
a selection module configured to select on and off of suppressing of the display luminance of the picture signal for the display control module in accordance with an instruction input by a user.
